(19) United States
(12) Patent Application Publication
(10) Pub. No.: US 2015/0220899 A1
(43) Pub. Date: Aug. 6, 2015

(54) COMMODITY DATA REGISTRATION APPARATUS AND CHECKOUT DATA TRANSMISSION METHOD

(71) Applicant: TOSHIBA TEC KABUSHIKI KAISHA, Tokyo (JP)

(72) Inventors: Shinya Namura, Mishima (JP); Nobuhiro Sugita, Mishima (JP); Takayuki Kawahara, Mishima (JP)

(21) Appl. No.: 14/609,501

(22) Filed: Jan. 30, 2015

(30) Foreign Application Priority Data
Jan. 31, 2014 (JP) 2014-017540

(51) Int. Cl. G06Q 20/20; G06Q 20/04

(52) U.S. Cl. CPC G06Q 20/204; G06Q 20/045

(57) ABSTRACT

A commodity data registration apparatus, connected with a checkout apparatus which executes settlement processing of one transaction of the commodity by operations of a customer through network, comprises a specification information determination module for determining specification information for specifying an input commodity; a calculation module for calculating a total amount of one transaction according to sales data based on the specified information; a cash voucher amount input module for inputting a cash voucher amount of one or multiple cash vouchers; a determination module for determining whether or not the input cash voucher amount is greater than the total amount; a change amount calculation module for calculating change amount according to the cash voucher amount and the total amount if the cash voucher amount is greater than the total amount; and a sending module for sending transaction data containing the change amount, the sales data and the total amount to the checkout apparatus.

### CROSS-REFERENCE TO RELATED APPLICATION

This application is based upon and claims the benefit of priority from Japanese Patent Application No. 2014-017540, filed Jan. 31, 2014, the entire contents of which are incorporated herein by reference.

### FIELD

Embodiments described herein relate generally to a commodity data registration apparatus and a method for executing transmission of a checkout data by the commodity data registration apparatus.

### BACKGROUND

Conventionally, there has been proposed a checkout system consisting of a commodity data registration apparatus which reads out a unit price and other information relating to a commodity according to a commodity code input through a reader and the like to generate transaction data of the commodity and a checkout apparatus through which a customer executes a settlement processing all by himself/herself based on the transaction data generated by the commodity data registration apparatus. Such a checkout system enables a shop clerk (checker) to save an operation time relating to the checkout job.

In accordance with such a checkout system described above, processing of the transaction data is halted and the transaction data is temporarily stored in the commodity data registration apparatus before the checkout processing is carried out by the checkout apparatus. The customer receives a reserve receipt on which identification data for identifying the transaction data temporarily stored in the commodity data registration apparatus is printed. Then the customer inputs through a reader or an input device the identification data printed on the reserve receipt in the checkout apparatus to transmit the transaction data temporarily stored in the commodity data registration apparatus to the checkout apparatus to carry out settlement processing by the checkout apparatus.

However, in a case in which a method of carrying out settlement with a cash voucher such as a voucher is selected from various settlement methods, a cash voucher amount is input in the commodity data registration apparatus. In this case, in a case of an over-tend state in which the input cash voucher amount is greater than the total amount of the commodities, a settlement processing is executed, the change is dispensed and a receipt is printed and issued in the commodity data registration apparatus. Thus, it is necessary to arrange a change dispensing machine and a receipt printer in the commodity data registration apparatus.

### BRIEF DESCRIPTION OF THE DRAWINGS

FIG. 1 is a schematic view illustrating the whole checkout system according to one embodiment;

FIG. 2 is a perspective view illustrating the appearance of a commodity data registration apparatus;

FIG. 3 is a perspective view illustrating the appearance of a checkout apparatus;

FIG. 4 is a block diagram illustrating the hardware constitutions of the commodity data registration apparatus and the checkout apparatus;

FIG. 5 is a memory map illustrating the hard disk of the commodity data registration apparatus;

FIG. 6 is a memory map illustrating another example of the hard disk of the commodity data registration apparatus;

FIG. 7 is a block diagram illustrating functional components of the commodity data registration apparatus;

FIG. 8 is a flowchart illustrating a control processing of the commodity data registration apparatus;

FIG. 9 is a diagram illustrating one example of a sales screen of the commodity data registration apparatus;

FIG. 10 is a diagram illustrating one example of a transmission destination selection screen;

FIG. 11 is a diagram illustrating one example of a notification screen;

FIG. 12 is a diagram illustrating one example of an information transmission screen;

FIG. 13 is a diagram illustrating another example of the transmission destination selection screen;

FIG. 14 is a flowchart illustrating a settlement processing carried out by the checkout apparatus; and

FIG. 15 is a diagram illustrating one example of a checkout screen in the checkout apparatus.

### DETAILED DESCRIPTION

In accordance with one embodiment, a commodity data registration apparatus, connected with a checkout apparatus which executes settlement processing of one transaction of a commodity by operations of a customer through a network, comprises a specification information determination module configured to determine specification information for specifying an input commodity; a calculation module configured to calculate a total amount of one transaction according to sales data based on the specified information; a cash voucher amount input module configured to input a cash voucher amount of one or a plurality of cash vouchers; a determination module configured to determine whether or not the input cash voucher amount is greater than the calculated total amount; a change amount calculation module configured to calculate change amount according to the cash voucher amount and the total amount in a case in which it is determined that the cash voucher amount is greater than the total amount; and a sending module configured to send transaction data containing the calculated change amount, the sales data and the total amount to the checkout apparatus.

In accordance with one embodiment, a commodity data registration method includes determining specification information for specifying an input commodity; calculating a total amount of one transaction according to sales data based on the specified information; inputting a cash voucher amount of one or a plurality of cash vouchers; determining whether or not the input cash voucher amount is greater than the calculated total amount; calculating change amount according to the cash voucher amount and the total amount in a case in which it is determined that the cash voucher amount is greater than the total amount; and sending transaction data containing the calculated change amount, the sales data and the total amount to a checkout apparatus.

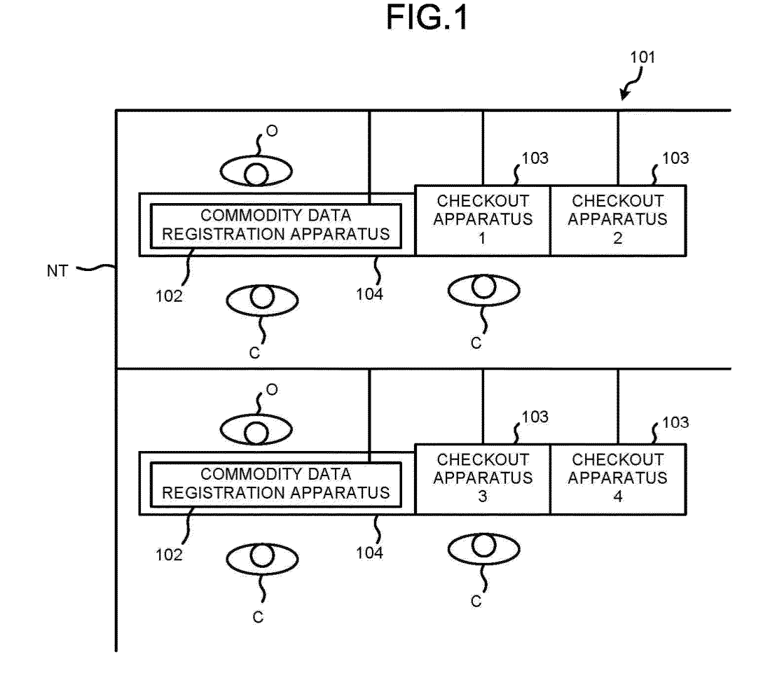

FIG. 1 is a schematic view illustrating the whole checkout system 101 according to the present embodiment. As shown in FIG. 1, the checkout system 101 includes a commodity data registration apparatus 102 operated by a checker O (shop clerk) and a checkout apparatus 103 operated by a customer C. The commodity data registration apparatus 102 is arranged on a horizontally extended work table 104. Each commodity data registration apparatus 102 and each checkout apparatus 103 are connected with one another through a network NT such as a LAN (Local Area Network) and the like.

In the present embodiment, two checkout apparatuses 103 are arranged for one commodity data registration apparatus 102. In the example shown in FIG. 1, two checkout apparatuses 103 (a checkout apparatus 1 and a checkout apparatus 2) are connected with one commodity data registration apparatus 102. Another two checkout apparatuses 103 (a checkout apparatus 3 and a checkout apparatus 4) are connected with another commodity data registration apparatus 102. Each checkout apparatus 103 is arranged linearly adjacent to the work table 104. Thus, a customer passage is formed between work tables 104 in the present embodiment.

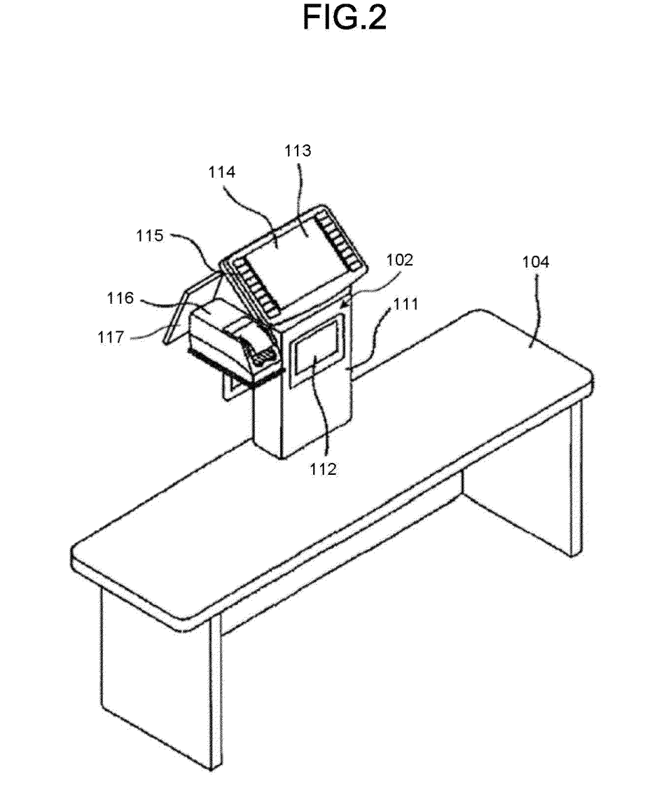

First, the commodity data registration apparatus 102 is described. FIG. 2 is a perspective view illustrating the appearance of the commodity data registration apparatus 102. As shown in FIG. 2, the commodity data registration apparatus 102 arranged on the work table 104 is basically equipped with a vertical scanner 111 having a reading window 112. The scanner 111 includes an image capturing section (not shown) arranged at the rear side of the reading window 112.

The commodity data registration apparatus 102 further includes a display device 114 with a touch panel 113 and an operation section 115 arranged at the upper portion of the scanner 111. The display device 114 displays a commodity name, a price and the like of a commodity photographed by the image capturing section of the scanner 111. The touch panel 113 and the operation section 115 are respectively used to assist input of commodity data.

A printer 116 is arranged at the left side of the commodity data registration apparatus 102. The printer 116 issues a receipt on which an identification data described later and a transaction data such as total amount of one transaction are printed.

A display for customer 117 for displaying information to the customer C is also arranged at the left side of the commodity data registration apparatus 102. The screen of the display for customer 117 is oriented to the customer C.

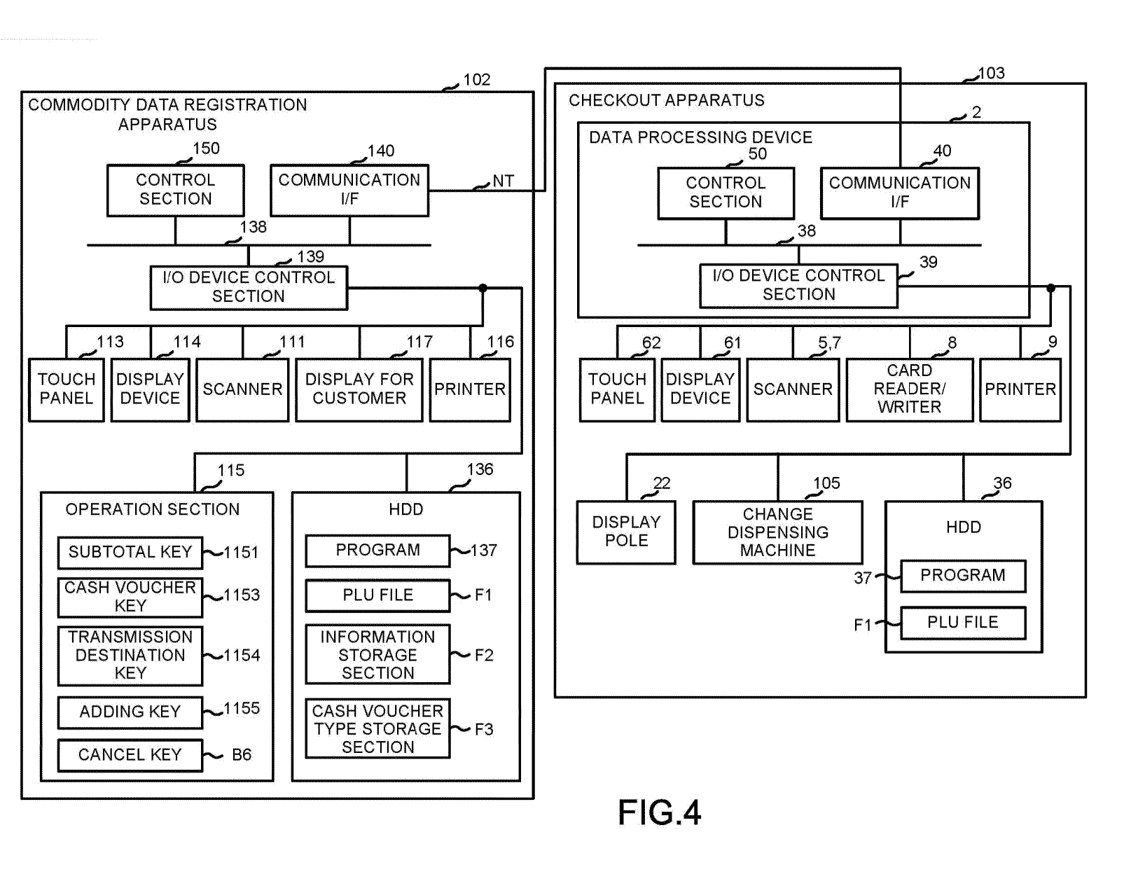

In the commodity data registration apparatus 102, a commodity contained in the image captured by the image capturing section is specified with reference to a PLU (Price Lookup table) File F1 (refer to FIG. 4) through a general object recognition or by reading code symbol such as a barcode or a QR code (registered trademark) attached to the commodity.

As to the general object recognition for recognizing an object contained in an image, various recognition technologies are described in the following document.

Keiji Yanai “Present situation and future of generic object recognition”, Journal of Data processing Society, Vol. 48, No. SIG16 [Search on Heisei 26 Jan. 6], Internet <URL: http://mm.cs.uec.ac.jp/IPSJ-TCVIM-Yanai.pdf>

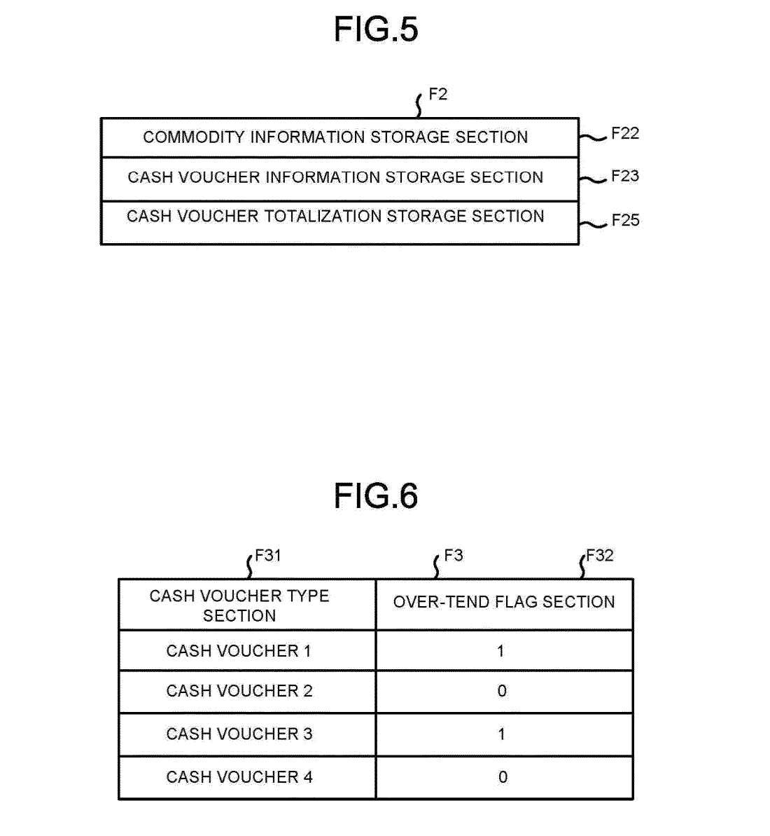

Next, the commodity data registration apparatus 102 displays a screen for receiving an input of the confirmation of the specified commodity and the quantity thereof on the display device 114. The commodity data registration apparatus 102 reads, based on the commodity code of the commodity of which the confirmation input is received and information such as the input quantity of commodity purchased and the like, commodity information such as information relating to sales registration such as a commodity category, commodity name, unit price and the like of the commodity corresponding to the commodity code from the PLU file F1, and stores the commodity information in a later-described commodity information storage section F22 (refer to FIG. 5) to carry out sales registration of the commodity.

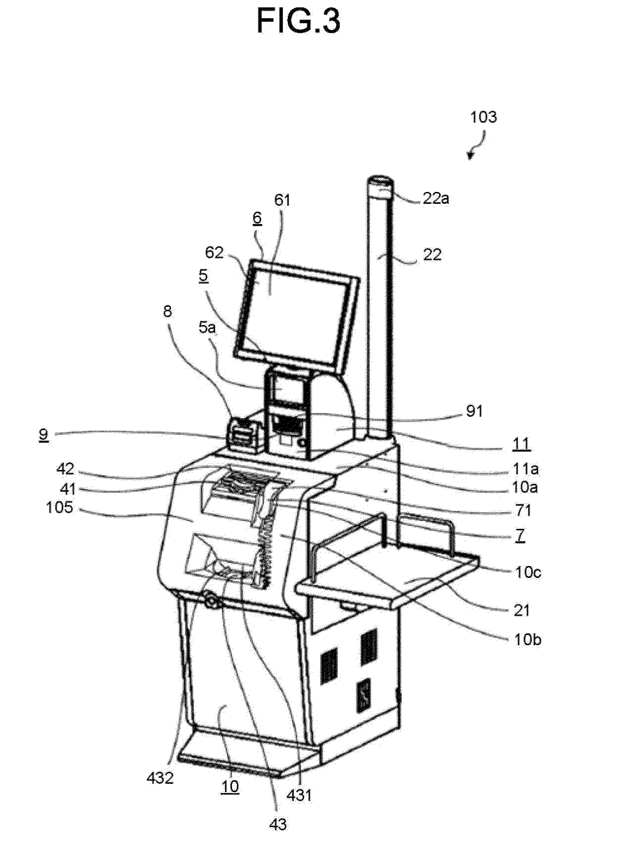

Next, the checkout apparatus 103 is described. FIG. 3 is a perspective view illustrating the appearance of the checkout apparatus 103. The checkout apparatus 103 according to the present embodiment can also function as a self-checkout POS (Point Of Sales) terminal, through which the customer C can carryout a commodity sales processing and a checkout processing, while no operator uses the checkout apparatus 103.

The checkout apparatus 103 includes a data processing device 2 (refer to FIG. 4), a change dispensing machine 105, a stationary scanner 5, a display operation panel 6, a handy scanner 7, a card reader/writer 8, a receipt printer 9, a first casing 10 and a second casing 11. The first casing 10, in which the data processing device 2 and the change dispensing machine 105 are arranged, is placed on the floor. The second casing 11 serving as a housing of the stationary scanner 5 and the receipt printer 9 is placed on an upper surface 10a of the first casing 10.

The stationary scanner 5 includes an image capturing window 5a arranged at the upper portion of the second casing 11 and an image capturing section (not shown) arranged inside the second casing 11. The image capturing section photographs a code symbol such as a barcode and the like held in front of the image capturing window 5a to capture the image of the code symbol and decodes the captured code symbol. The image capturing section outputs the decoded code data to the data processing device 2. In a case of carrying out general object recognition, the image capturing section outputs a commodity image captured by photographing the commodity held in front of the image capturing window 5a to the data processing device 2.

The handy scanner 7 is movably arranged at the upper portion of a front side 10b of the first casing 10. A holding section 10c for holding the handy scanner 7 by hooking a front end part 71 of the handy scanner 7 is arranged at the upper right portion of the front side 10b of the first casing 10.

The display operation panel 6 including a display device 61 and a touch panel 62 is mounted on the second casing 11. The display device 61 displays an image under the control of the data processing device 2. The touch panel 62 arranged on the surface of the display device 61 outputs information based on a position touched by the operator O to the data processing device 2.

The card reader/writer 8 is arranged adjacent to the second casing 11 on the upper surface 10a of the first casing 10. The card reader/writer 8 executes reading/writing operation of information from or to a magnetic card (data recording medium) such as a point card, a credit card and the like.

The change dispensing machine 105 includes a cash depositing port 41, a bill dispensing port 42 and a coin dispensing section 43. The coin dispensing section 43 includes a dispensing port 431 and a coin tray 432. The change dispensing machine 105 receives bills and coins deposited through the cash depositing port 41, and stores the bills and the coins separately. The change dispensing machine 105 dispenses change through the dispensing port 431 in response to a request of the data processing device 2. The dispensed change is received by the coin tray 432.

The receipt printer 9 includes a well-known printing section (not shown) arranged inside the second casing 11 and a receipt issuing port 91 arranged at the front side 11a of the second casing 11. The receipt printer 9 issues a receipt printed by the printing section from the receipt issuing port 91 under the control of the data processing device 2.

The data processing device 2 arranged inside the first casing 10 collectively controls each section (the change dispensing machine 105, the stationary scanner 5, the display operation panel 6, the handy scanner 7, the card reader/writer 8 and the receipt printer 9) of the checkout apparatus 103. The data processing device 2 acquires code information or a commodity image from the stationary scanner 5 or the handy scanner 7. The data processing device 2 outputs information to be displayed on the display device 61 of the display operation panel 6, and acquires information of an operation carried out by the operator through the touch panel 62. The data processing device 2 grasps the amount of cash deposited from the change dispensing machine 105 and instructs a dispensing of cash to the change dispensing machine 105.

The checkout apparatus 103 includes a basket placing table 21 arranged at one of the sides of the first casing 10. The basket placing table 21 is used for placing a shopping basket when the customer C carries out the settlement processing.

The checkout apparatus 103 is further equipped with a display pole 22 which is vertically mounted on an upper surface 10a of the first casing 10 and serves as a notification section for displaying the current operation status of the checkout apparatus 103. The display pole 22 includes a light emitting section 22a, which selectively emits blue and red light, at the top end thereof.

Next, the hardware constitutions of the commodity data registration apparatus 102 and the checkout apparatus 103 are described. FIG. 4 is a block diagram illustrating the hardware constitutions of the commodity data registration apparatus 102 and the checkout apparatus 103.

As shown in FIG. 4, the commodity data registration apparatus 102 includes a control section 150 constituted with a computer consisting of, for example, a CPU (Central Processing Unit), a ROM (Read Only Memory) and a RAM (Random Access Memory) (none is shown) serving as storage media. The ROM stores various programs executed by the CPU and various data. The RAM stores not only programs and data temporarily when the CPU executes various programs, but also sales data indicating commodity sales records and various screen display data displayed on the display device 114.

The control section 150 controls I/O devices such as the scanner 111, the touch panel 113, the display device 114, the operation section 115 such as a keyboard and the like, the printer 116, the display for customer 117 and an HDD (Hard Disk Drive) 136 through an I/O (Input/Output) device control section 139 and a bus line 138 to control the whole system of the commodity data registration apparatus 102.

The operation section 115 includes a subtotal key 1151 for declaring the completion of one transaction, a cash voucher key 1153 for declaring settlement with cash voucher, a transmission destination key 1154 for designating the transmission destination of the transaction data, an adding key 1155 for declaring an additional payment method and a cancel key B6 for canceling the settlement based on the cash voucher.

The HDD 136, i.e., storage module, stores a PLU file F1 and a program 137 executable by the CPU of the control section 150. The PLU file F1 stores a commodity code uniquely assigned to each commodity in association with information relating to the commodity such as the name, price, commodity category and the like of the commodity. In a case of specifying a commodity through the general object recognition, the PLU file F1 also stores feature amount such as hue, surface concave-convex state extracted from the commodity image. The HDD 136 further stores the information storage section F2 (refer to FIG. 5) and a cash voucher type storage section F3 (refer to FIG. 6).

The program 137 for operating the CPU of the control section 150 of the commodity data registration apparatus 102 is recorded in a computer-readable recording medium such as a CD-ROM, flexible disk (FD), CD-R, DVD (Digital Versatile Disk) and the like in the form of installable or executable file to be provided.

Further, the program 137 may be stored in a computer connected with a network such as Internet, and downloaded via the network. Alternatively, the program 137 may also be provided or distributed via a network such as Internet.

The control section 150 can communicate, through a communication I/F 140, with the checkout apparatus 103 and a store server (not shown) connected through the network NT.

The store server generally carries out management on the commodity sales registration processing carried out by the one or a plurality of commodity data registration apparatuses 102 and the settlement processing carried out by the checkout apparatus 103 and the like arranged in the store.

On the other hand, as shown in FIG. 4, the checkout apparatus 103 includes a control section 50 constituted with a computer consisting of, for example, a CPU, a ROM and a RAM (none is shown) serving as storage media in the data processing device 2. The ROM stores various programs executed by the CPU and various data. The RAM stores not only programs and data temporarily when the CPU executes various programs, but also sales data indicating commodity sales records and various screen display data displayed on the display device 61.

The control section 50 controls I/O devices such as the touch panel 62, the display device 61, the stationary scanner 5, the handy scanner 7, the card reader/writer 8, the receipt printer 9, the change dispensing machine 105, the display pole 22 and an HDD 36 through an I/O device control section 39 and a bus line 38 to control the whole system of the checkout apparatus 103.

The card reader/writer 8 reads information of the point card and credit card of the customer inserted into a card insertion port. The receipt printer 9 prints a receipt after the settlement processing is completed to issue it from the receipt issuing port 91. The change dispensing machine 105 processes the bills and the coins deposited from the cash depositing port 41. The change dispensing machine 105 dispenses change from the dispensing port 431 in response to a request.

The HDD 36, i.e., storage module, stores a PLU file F1 and a program 37 executable by the control section 50.

The program 37 for operating the CPU of the control section of the checkout apparatus 103 is recorded in a computer-readable recording medium such as a CD-ROM, flexible disk (FD), CD-R, DVD (Digital Versatile Disk) and the like in the form of installable or executable file to be provided.

Further, the program 37 may be stored in a computer connected with a network such as Internet, and downloaded via the network. Alternatively, the program 37 may also be provided or distributed via a network such as the Internet.

The control section 50 can communicate, through a communication I/F 40, with the commodity data registration apparatus 102 and a store server (not shown) connected through the network NT such as a LAN and the like.

Next, the information storage section F2 stored in the HDD 136 is described with reference to FIG. 5. In FIG. 5, the information storage section F2 includes a commodity information storage section F22, a cash voucher information storage section F23 and a cash voucher totalization storage section F25.

The commodity information storage section F22 stores the commodity information (commodity name, price and the like) read from the PLU file F1 on the basis of the commodity code read and input by the scanner 111. The commodity information storage section F22 stores the commodity information corresponding to all the input commodity codes.

The cash voucher information storage section F23 stores cash voucher information containing the cash voucher amount of the cash voucher read and input by the scanner 111. The cash voucher information storage section F23 stores all the input cash voucher information in a case in which a plurality of cash vouchers is used and therefore a plurality kinds of cash voucher information is input.

The cash voucher totalization storage section F25 stores the cash voucher information of all the cash vouchers used by the customer during a predetermined period (for example, one year). The cash voucher information stored in the cash voucher information storage section F23 is analyzed to manage the cash voucher usage status of each customer such as the trend of the types of the used cash vouchers, the cash voucher amount and the like. Though the analysis of the cash voucher information can be carried out by the commodity data registration apparatus 102; however, it is preferred to send the cash voucher information to a higher-level server (not shown) to collectively analyze the information by the server.

Next, the cash voucher type storage section F3 is described with reference to FIG. 6. In FIG. 6, the cash voucher type storage section F3 includes a cash voucher type section F31 and an over-tend flag section F32. The cash voucher type section F31 stores the types of the cash vouchers that can be used in the store for each cash voucher. In the example shown in FIG. 6, four types of cash vouchers (cash voucher 1-cash voucher 4) are stored respectively. The cash voucher information is preset in the cash voucher type storage section F3. In addition, the type information of cash voucher stored in the cash voucher type section F31 and the over-tend flag information stored in the over-tend flag section F32 can be changed.

The over-tend flag section F32 stores a flag indicating whether or not it is over-tend OK for each cash voucher stored in the cash voucher type section F31. The “over-tend” refers to that the cash voucher amount of the cash voucher is greater than the total amount. The “over-tend OK” refers to that the cash voucher can be used even if the cash voucher amount of the cash voucher is greater than the total amount. That is, in a case in which an over-tend flag “1” is stored in the over-tend flag section F32, it indicates that the cash voucher can be used in spite of the over-tend.

As to the cash voucher with an over-tend flag “1”, the cash voucher can still be used, even if it is not over-tend unless a plurality of the cash vouchers is used. For example, even if the total cash voucher amount of two cash vouchers is greater than the total amount, the two cash vouchers can be used. In the example shown in FIG. 6, the cash voucher 1 and the cash voucher 3 are over-tend OK.

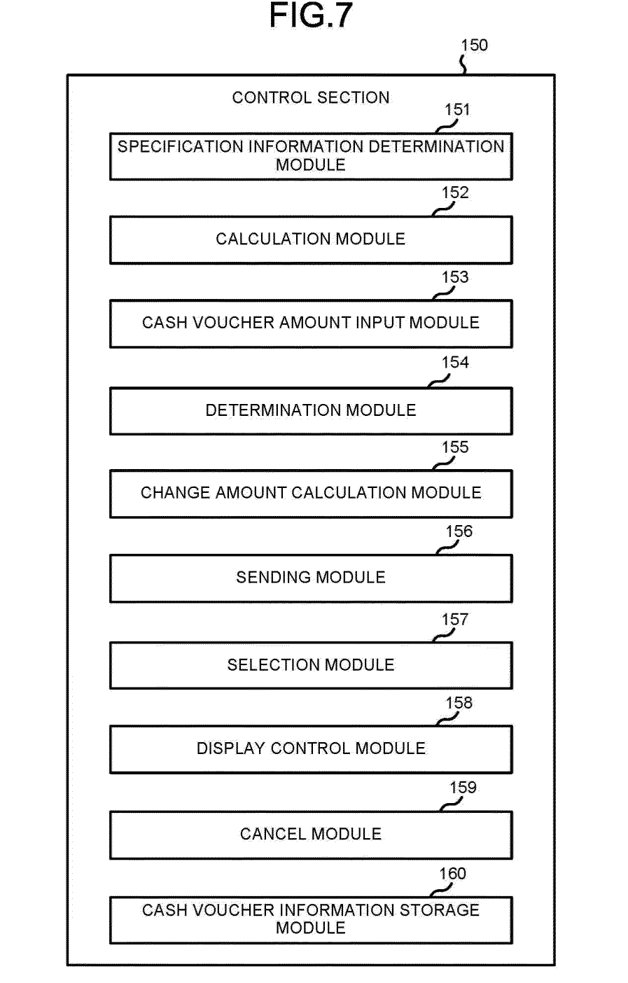

Next, the functional components of the control section 150 realized by the CPU of the control section 150 of the commodity data registration apparatus 102 which executes the program 137 and the functional components of the control section 50 realized by the CPU of the control section 50 of the checkout apparatus 103 which executes the program 37 are described with reference to FIG. 7-FIG. 15.

FIG. 7 is a block diagram illustrating functional components of the commodity data registration apparatus 102. As shown in FIG. 7, the control section 150 of the commodity data registration apparatus 102 executes the program 137 stored in the HDD 136 to realize functions of a specification information determination module 151, a calculation module 152, a cash voucher amount input module 153, a determination module 154, a change amount calculation module 155, a sending module 156, a selection module 157, a display control module 158, a cancel module 159 and a cash voucher information storage module 160.

The specification information determination module 151 determines the specification information for specifying the input commodity.

The calculation module 152 calculates the total amount in one transaction according to the sales data based on the determined specification information.

The cash voucher amount input module 153 inputs the cash voucher amount of one or a plurality of cash vouchers.

The determination module 154 determines whether or not the input cash voucher amount is greater than the total amount.

The change amount calculation module 155 calculates a change amount according to the cash voucher amount and the total amount in a case in which it is determined that the cash voucher amount is greater than the total amount.

The sending module 156 sends the transaction data containing the calculated change amount, the sales data and the total amount to the checkout apparatus 103.

The selection module 157 selects one of the checkout apparatuses in a case in which there is more than one checkout apparatus connected through the network.

The display control module 158 displays the total amount and information indicating the checkout apparatus serving as the transmission destination on the display device at the time the sending process is carried out by the sending module 156.

The cancel module 159 can cancel the input cash voucher amount prior to the sending of the change amount and the transaction data by the sending module 156.

The cash voucher information storage module 160 stores the input cash voucher amount and the type of the cash voucher in a totalizable manner.

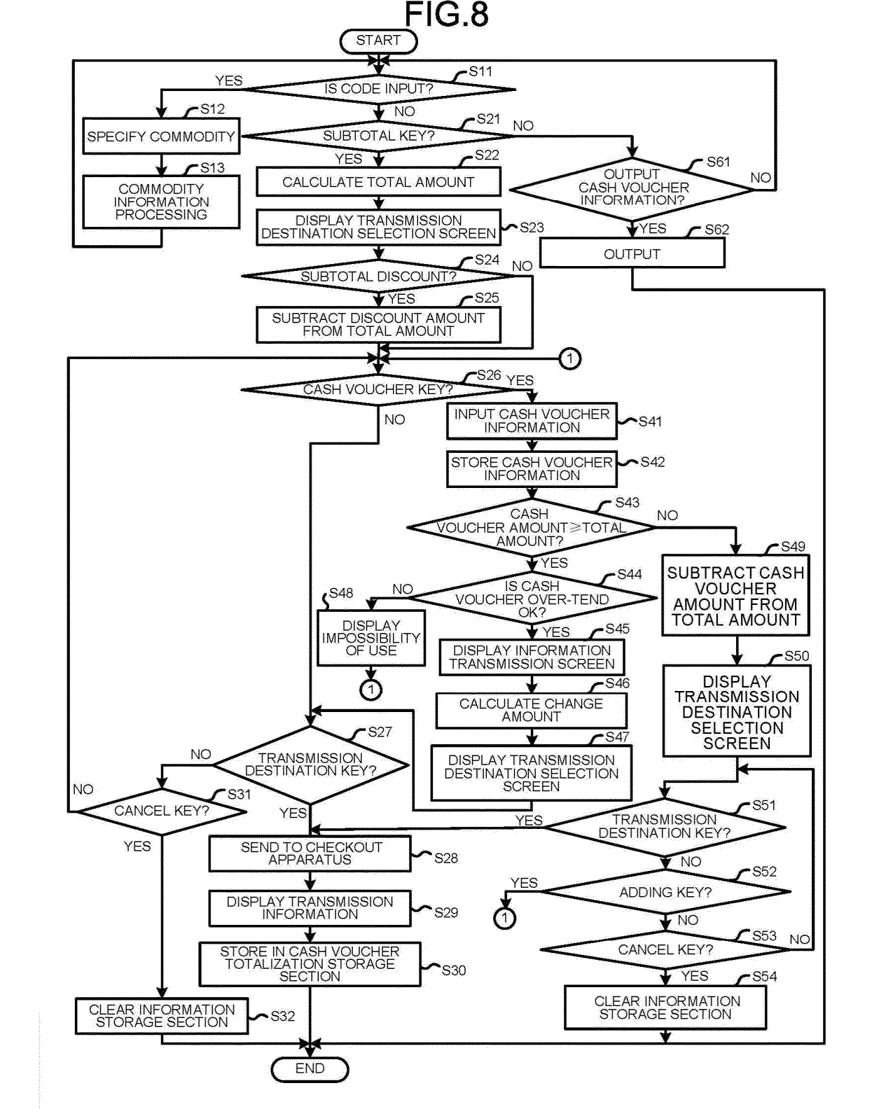

Next, operation of the checkout system 101 is described in detail. First, operation of the commodity data registration apparatus 102 is described. FIG. 8 is a flowchart illustrating commodity sales registration processing carried out by the commodity data registration apparatus 102.

As shown in FIG. 8, the control section 150 of the commodity data registration apparatus 102 determines whether or not the commodity code serving as the specification information for specifying the commodity is read by the scanner 111 (ACT S11). If it is determined that the commodity code is read (YES in ACT S11), the control section 150 (specification information determination module 151) specifies the commodity based on the read commodity code (ACT S12). The specification of the commodity is carried out by designating the commodity corresponding to the commodity code with reference to the PLU file F1 based on the read commodity code. Then the control section 150 executes the sales processing of the specified commodity based on the commodity information of the commodity (ACT S13). Specifically, the control section 150 reads the commodity information (commodity name, price and the like) serving as the sales data from the PLU file F1 based on the read commodity code and stores the commodity information in the commodity information storage section F22 of the information storage section F2. The control section 150 displays the read commodity information on the display device 114 as the sales screen P1.

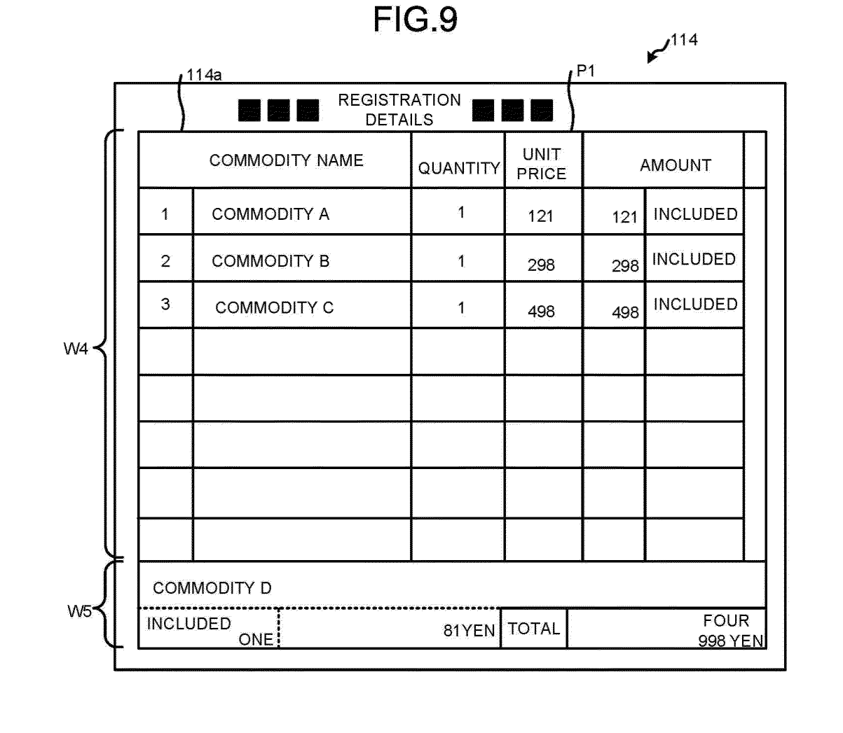

FIG. 9 is a front view illustrating an example of the sales screen P1. As shown in FIG. 9, the control section 150 controls the display device 114 to display the sales screen 91 in a display area 114a of the display device 114 while the commodity sales registration processing is executed. The sales screen P1 includes a sales commodity window W5 and a window for showing sales completion W4 (hereinafter referred to as a registration completion window).

The commodity name, commodity unit price, individual commodity quantity and the like contained in the commodity information of the commodity specified through the commodity specification processing are displayed in the sales commodity window W5. The commodity name, commodity unit price and the individual commodity quantity displayed in the registration window W5 is are updated through the processing in ACT S11 and ACT S12. The total amount and the total commodity quantity are also displayed in the sales commodity window W5. The total amount and the total commodity quantity are also updated through the processing in ACT S11 and ACT S12.

The history displayed in the sales commodity window W5 is displayed in the sales completion window W4. In a case in which the processing in ACT S11 and ACT S12 is executed newly, the commodity name, commodity unit price, individual commodity quantity and the like displayed In the sales commodity window W5 are additionally displayed In the sales completion window W4.

On the other hand, if it is determined that the commodity code is not read by the scanner 111 (NO in ACT S11), the control section 150 determines whether or not the subtotal key 1151 is operated (ACT S21). If it is determined that the subtotal key 1151 is operated (YES in ACT S21), the control section 150 (calculation module 152) calculates the total amount based on the commodity information stored in the commodity information storage section F22 (ACT S22). Then the control section 150 displays a transmission destination selection screen P2 containing a selection screen for selecting a payment method of the transaction (ACT S23).

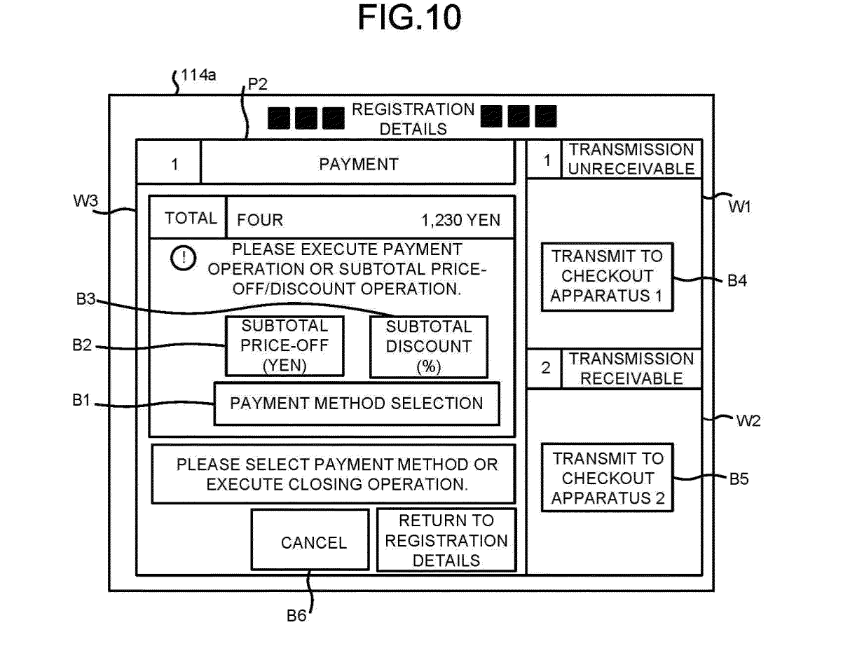

FIG. 10 is a front view illustrating an example of the transmission destination selection screen P2. As shown in FIG. 10, the control section 150 controls the display device 114 to display, in the display area 114a of the display device 114, the transmission destination selection screen P2 in which a payment amount display window W3, a first transmission destination window W1 and a second transmission destination window W2 are defined in advance. The payment amount display window W3, arranged at the left end, has a width more than half of that of the display device 114 and a height extending to nearly the upper end and the lower end of the display device 114. The first transmission destination window W1 and the second transmission destination window W2 are arranged vertically adjacent to each other between the right side of the display device 114 and the right side of the payment amount display window W3 in FIG. 10.

The total amount and the total quantity of the commodity at the time of the input by the closing operation are displayed in the payment amount display window W3. In the payment amount display window W3, a payment method selection key B1 for selecting a payment method, a subtotal price-off key B2 for carrying out subtotal price-off and a subtotal discount key B3 for carrying out subtotal discount are arranged.

On the other hand, in the first transmission destination window W1 and the second transmission destination window W2, transmission receivable/unreceivable information indicating whether each checkout apparatus 103 serving as a transmission destination candidate is in a transmission receivable state or in a transmission unreceivable state as of the present time is displayed together with an identification number of each checkout apparatus 103. In addition, transmission destination keys B4 and B5 for declaring transmission are respectively arranged in the first transmission destination window W1 and the second transmission destination window W2. The transmission destination key B4 is a declaration key for sending the commodity information and the total amount information to the checkout apparatus 1. The transmission destination key B5 is a declaration key for sending the commodity information and the total amount information to the checkout apparatus 2. In a case in which the settlement processing is being executed in one of the checkout apparatuses 103, for example, the transmission unreceivable state is displayed in one of the first and second transmission destination windows W1 or W2 (W1 in FIG. 10), but the transmission destination keys B4 and B5 for declaring transmission can be operated. This is because that, in general, the checkout processing in the checkout apparatus 103 is completed in short time and thus the display is changed to the transmission receivable state shortly even if the transmission unreceivable state is being displayed.

For example, in a case of paying with the cash voucher, the payment method selection key B1 is operated, and then any transmission destination key is operated. In a case of paying in cash, any transmission destination key is operated without operating the payment method selection key E1.

The method for selecting the checkout apparatus 103 as the transmission destination is not limited to the operation on the transmission destination keys 54 and B5. For example, the checkout apparatus 103 serving as the transmission destination may be selected through a combined operation on a numeric key and a sending key arranged on the operation section 115. Specifically, the checkout apparatus 103 corresponding to the first transmission destination window W1 can be selected through the combined operation on a numeric key “1” and a sending key.

For example, in a case of sending the transaction data to other checkout apparatus 103 such as the checkout apparatus 3 or the checkout apparatus 4 that is not displayed in the transmission destination selection screen P2, the operator can specify the checkout apparatus through the numeric key and then operate the sending key to send the transaction data to the desired checkout apparatus. As stated above, the identification number of the checkout apparatus 103 serving as the transmission destination can be designated freely through a combined operation on the numeric key and the sending key arranged on the operation section 115, in this way, the transaction data can also be transmitted to a checkout apparatus 103 other than the pre-designated checkout apparatus 103.

The control section 150 determines whether or not the subtotal price-off key B2 or the subtotal discount key B3 in the transmission destination selection screen P2 is operated due to the use of a coupon and the like (ACT S24). If it is determined that the subtotal price-off key B2 or the subtotal discount key B3 is operated (YES in ACT S24), the control section 150 subtracts a discount amount from the total amount calculated in ACT S22 (ACT S25).

Then the control section 150 determines whether or not the cash voucher key 1153, which is displayed when the payment method selection key B1 is operated and is pressed when desiring to carry out settlement with a cash voucher such as a voucher, is operated (ACT S26). If it is determined that the cash voucher key 1153 is not operated (that is, in a case in which it is selected to pay in cash) (NO in ACT S26), the control section 150 (selection module 157) determines whether or not either of the transmission destination key B4 or the transmission destination key 55 is operated (ACT S27).

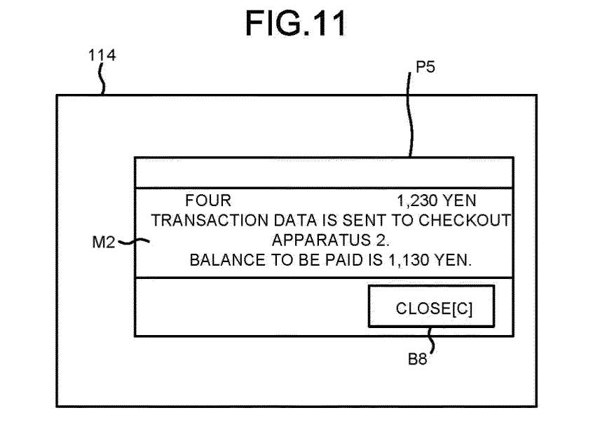

If it is determined that either of the transmission destination key B4 or the transmission destination key B5 is operated (YES in ACT S27), the control section 150 (sending module 156) transmits the transaction data to the checkout apparatus 103 designated through the operation (ACT S28). At this time, the reserve receipt printed with the information for specifying the transaction data is not issued from the printer 116 of the commodity data registration apparatus 102. The control section 150 (display control module 158) displays a notification screen P5 as shown in FIG. 11 on the display device 114 (ACT S29). The operator who sees the notification screen P5 tells the customer to go to the checkout apparatus 103 with the displayed number to carry out settlement.

In FIG. 11, the control section 150 displays the notification screen P5 indicating that the transaction data is sent to the desired checkout apparatus 103 on the display device 114. The total amount and the total commodity quantity are also displayed in the notification screen P5. Further, in a case in which the subtotal discount or the subtotal price-off is executed, the balance obtained by the execution of the subtotal discount or the subtotal price-off is also displayed. The notification screen P5 is closed when a closing key B8 is operated.

The control section 150 displays the notification screen P5 on the display device 114 oriented to the operator; however, it is not limited to this. The notification screen P5 may be displayed on the display for customer 117 oriented to the customer. In this case, the customer C may also be notified that the transaction data is sent to the checkout apparatus 103.

Return to the description of FIG. 8. The control section 150 (cash voucher information storage module 160) stores the cash voucher information such as the type of the cash voucher, the cash voucher amount, the over-tend flag information and the like sent to the checkout apparatus 103 in the cash voucher totalization storage section F25 (ACT S30). The cash voucher information stored in ACT S30 is accumulated for each predetermined period (for example, one year) in the cash voucher totalization storage section F25. It is possible to analyze the cash voucher usage status of the customer such as the type of the used cash voucher, the cash voucher amount, the over-tend frequency and the like by analyzing the cash voucher totalization storage section F25. Further, there is no cash voucher information in a case of paying in cash, thus, there is no information to be stored in the cash voucher totalization storage section F25 in ACT S30.

On the other hand, if it is determined in ACT S27 that neither the transmission destination key B4 nor the transmission destination key B5 is operated (NO in ACT S27), the control section 150 determines whether or not the cancel key B6 is operated (ACT S31). If it is determined that the cancel key B6 is operated (YES in ACT S31), the control section 150 (cancel module 159) clears the information stored in the cash voucher information storage section F23 (ACT S32). That is, all the information relating to the payment with the cash voucher operated until now can be cleared by operating the cancel key B6, as long as the transmission destination key is not operated yet. Further, in a case of paying in cash, there is no information to be cleared even if the cancel key B6 is operated.

On the other hand, if it is determined in ACT S26 that the cash voucher key 1153 is operated (that is, in a case in which it is selected to pay with the cash voucher) (YES in ACT S26), the control section 150 (cash voucher amount input module 153) reads a barcode printed on the cash voucher such as a voucher by the scanner 111 to input the cash voucher information (ACT S41). Then the input cash voucher information is stored in the cash voucher information storage section F23 (ACT S42). Next, the control section 150 (determination module 154) compares the total amount calculated in ACT S22 and stored in the commodity information storage section F22 with the cash voucher amount contained in the cash voucher information stored in ACT S42 to determine whether or not the cash voucher amount is equal to or greater than the total amount (ACT S43).

If it is determined that the cash voucher amount is greater than the total amount (YES in ACT S43), the control section 150 determines whether or not the cash voucher stored in the cash voucher information storage section F23 is over-tend OK (ACT S44). The “over-tend” refers to that the cash voucher amount of the cash voucher is greater than the total amount. There is a type of cash voucher for which no change is dispensed, and the control section 150 does not allow over-tend for this type of cash voucher. The control section 150 determines whether or not the cash voucher is over-tend OK based on the cash voucher information stored in the cash voucher type storage section F3 with reference to the over-tend flag stored in the over-tend flag section F32 of the cash voucher type storage section F3.

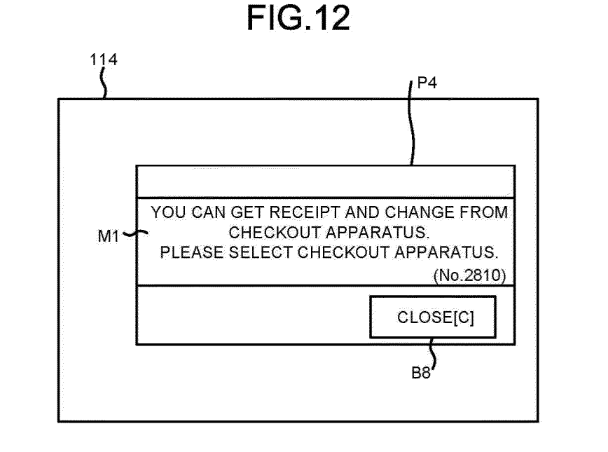

If it is determined that the cash voucher is over-tend OK (YES in ACT S44), it is not necessary to input more cash voucher amount, thus, the control section 150 displays a message which indicates the settlement processing by the checkout apparatus 103 and asks for selection of the checkout apparatus (ACT S45). FIG. 12 is a diagram illustrating an example of the message that indicates the settlement processing by the checkout apparatus 103 and asks for selection of the checkout apparatus. In FIG. 12, on the display device 114 is displayed a message P4 in which a message text M1 that indicates the dispensing of change and the issuing of a receipt and asks for selection of the desired checkout apparatus 103 is displayed. A closing key B8 for closing the message P4 is further displayed in the message P4.

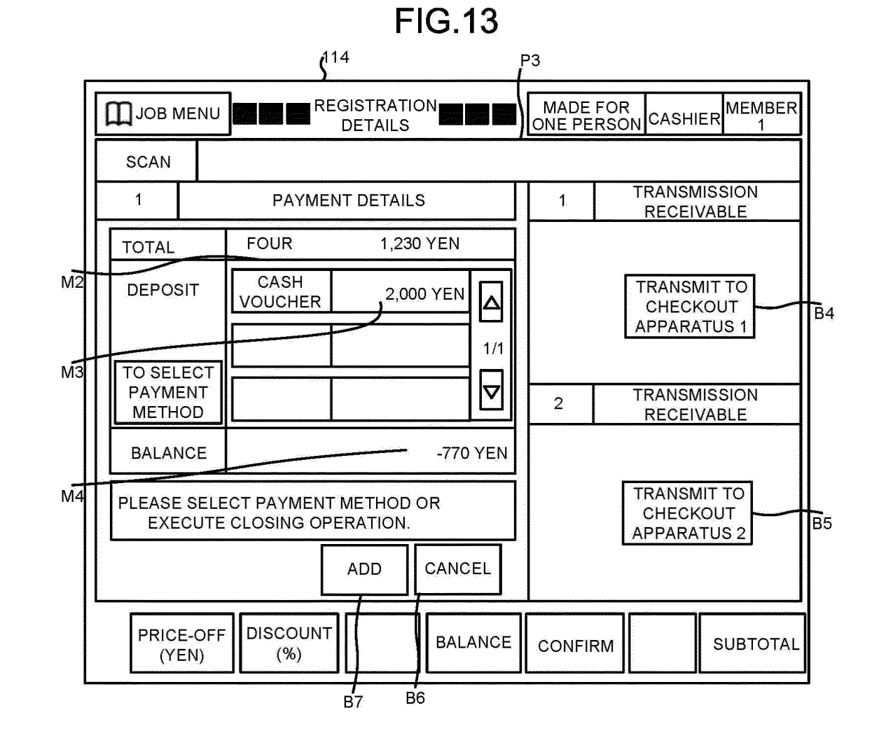

When the closing key B8 is operated, the control section 150 (change amount calculation module 155) calculates a difference amount between the cash voucher amount and the total amount compared in ACT S43 to calculate a change amount (ACT S46). The control section 150 displays a transmission destination selection screen P3 on the display device 114 (ACT S47). FIG. 13 is a diagram illustrating an example of the transmission destination selection screen P3. In FIG. 13, the transmission destination selection screen P3 displays a commodity information display part M2 for displaying the quantity of the purchased commodity and the total amount, a cash voucher amount display part M3 for displaying the cash voucher amount of the input voucher and a difference amount display part M4 for displaying the difference amount calculated in ACT S46.

In a case in which the numeric value in the difference amount display part M4 is positive (+), it is not over-tend, and the numeric value indicates the amount remained to be paid is displayed. In a case in which the numeric value in the difference amount display part M4 is negative (−), it is over-tend, and the numeric value indicates the change amount to be dispensed from the checkout apparatus 144. In the example shown in FIG. 13, the numeric value in the difference amount display part M4 is −770 YEN, which means that the change amount is 770 YEN. Further, the cancel key B6 and an adding key B7 for inputting the additional cash voucher are displayed in the transmission destination selection screen 93. Then the control section 150 executes the control following ACT S27. At this time, the reserve receipt printed with the information for specifying the transaction data is not issued from the printer 116 of the commodity data registration apparatus 102 even if the transaction data is sent to checkout apparatus 103 in ACT S28.

Then the control section 150 executes the processing following ACT S27. In this case, the change amount calculated in ACT S46 is also sent to the checkout apparatus 103 together with the transaction data in ACT S28. The checkout apparatus 103 dispenses change to the customer C based on the change amount. The checkout apparatus 103 prints and issues a receipt based on the change amount and the transaction data. In a case in which the cash voucher amount is equal to the total amount, the change amount is 0 YEN, the checkout apparatus 103 prints and issues a receipt based on the transaction data without dispensing change.

On the other hand, if it is determined in ACT S43 that the cash voucher amount is smaller than the total amount (NO in ACT S43), the control section 150 calculates the difference amount between the total amount stored in the commodity information storage section F22 and the cash voucher amount stored in the cash voucher information storage section F23 (ACT S49), and then displays the transmission destination selection screen P3 based on the difference amount (ACT S50). At this time, the total amount is displayed in the commodity information display part M2, the cash voucher amount is displayed in the cash voucher amount display part M3, and the calculated difference amount is displayed in the difference amount display part M4. In this case, the difference amount is a positive value.

Next, the control section 150 determines whether or not either of the transmission destination key B4 or the transmission destination key B5 is operated (ACT S51). If it is determined that either of the transmission destination key B4 or the transmission destination key B5 is operated (YES in ACT S51), the control section 150 executes the processing following ACT S28. On the other hand, if it is determined that neither the transmission destination key B4 nor the transmission destination key B5 is operated (NO in ACT S51), the control section 150 determines whether or not the adding key B7 is operated (ACT S52). If it is determined that the adding key B7 is operated (YES in ACT S52), the control section 150 returns to execute the processing in ACT S26.

If it is determined that the adding key B7 is not operated (NO in ACT S52), the control section 150 (cancel module 159) determines whether or not the cancel key 56 is operated (ACT S53). If it is determined that the cancel key 56 is operated (YES in ACT S53), the control section 150 clears the information of the cash voucher information storage section F23 of the information storage section F2 (ACT S54). On the other hand, if it is determined that the cancel key B6 is not operated (NO in ACT S53), the control section 150 returns to ACT S51 and wait.

Further, if it is determined in ACT S44 that the cash voucher is not over-tend OK (that is, in a case of a cash voucher of which the over-tend flag stored in the over-tend flag section F32 is “0”) (NO in ACT S44), the control section 150 displays a message indicating that the cash voucher cannot be used in a case of over-tend on the display device 114 (ACT S48). Then the control section 150 returns to ACT S26 and wait.

If it is determined in ACT S21 that the subtotal key 1151 is not operated (NO in ACT S21), the control section 150 determines whether or not the output of the cash voucher information is instructed (ACT S61). If it is determined that the output of the cash voucher information is instructed (YES in ACT S61), the control section 150 outputs the management information relating to the cash voucher such as the cash voucher type, the cash voucher amount, the use date and the like based on the information such as the type of the cash voucher, the cash voucher amount and the like stored in the cash voucher totalization storage section F25 (ACT S62). Otherwise, the control section 150 returns to ACT S11 and wait.

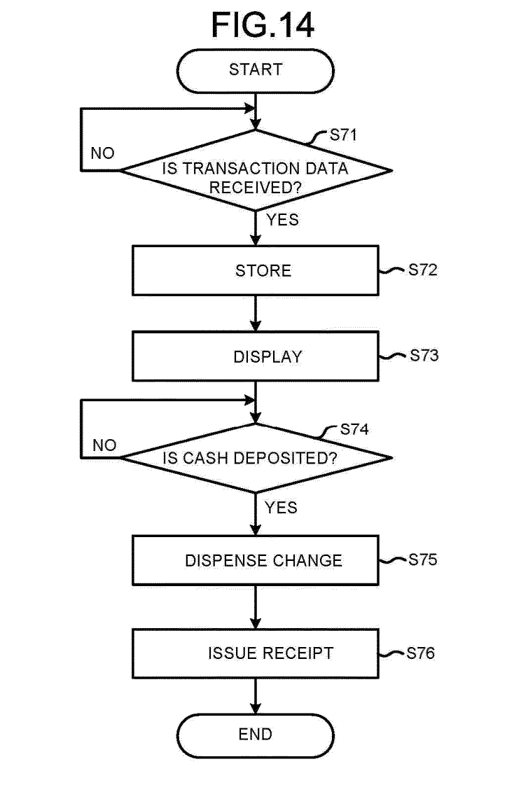

Next, the operation of the checkout apparatus 103 which is operated by the customer to execute the settlement processing by himself/herself is described. FIG. 14 is a flowchart illustrating the settlement processing carried out by the checkout apparatus 103.

As shown in FIG. 14, when the control section 50 of the checkout apparatus 103 receives the transaction data (checkout data) from the commodity data registration apparatus 102 (YES in ACT S71), the received transaction data is stored in the work area of the RAM (ACT S72).

Next, the control section 50 displays the total amount (or the balance obtained by the execution of the subtotal discount or subtotal price-off) of one transaction contained in the received transaction data on the display device 61 of the display operation panel 6 (ACT S73).

Sequentially, the control section 50 receives the cash deposited by the customer through the cash depositing port 41 of the change dispensing machine 105 (ACT S74).

If the cash the amount of which is more than the total amount (or the balance obtained by the execution of the subtotal discount or the subtotal price-off) displayed on the display device 61, is deposited through the cash depositing port 41 of the change dispensing machine 105 (YES in ACT S74), the control section 50 calculates the difference in amount from the total amount (or the balance obtained after the execution of the subtotal discount or the subtotal price-off) and the payment or depositing amount to dispense the calculated difference through the bill dispensing port 42 and/or the coin dispensing section 43 as the change amount (ACT S75).

Then the control section 50 controls the receipt printer 9 to issue a receipt on which the received transaction data, the payment amount (deposit amount) and the change amount are printed from the receipt issuing port 91 (ACT S76), and then the settlement processing is terminated.

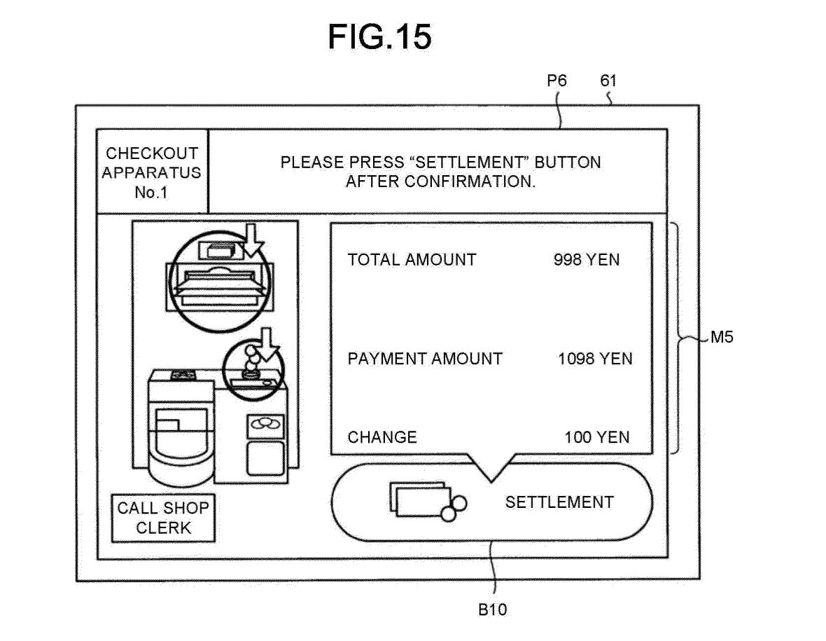

FIG. 15 is a diagram illustrating an example of a settlement screen P6 displayed on the display device 61 of the checkout apparatus 103 after the settlement processing is executed by the checkout apparatus 103. In FIG. 15, a message M5 indicating the total amount (998 YEN) of the transaction, the amount (1098 YEN) paid by the customer and the change amount (100 YEN), and a settlement key B10 for dispensing the change are displayed. If the customer operates the settlement key B10, the change is dispensed, and the settlement processing for the transaction in the checkout apparatus 103 is terminated.

In the commodity data registration apparatus 102 according to the present embodiment, it is also possible, like a conventional apparatus, to temporarily store the transaction data in a store server and the like and then issue a reserve receipt on which the identification data and the like for identifying the temporarily stored transaction data is printed. In this case, a storage key is arranged on the display device 114 with the touch panel 113 or the operation section 115, and the control section 150 of the commodity data registration apparatus 102 executes the storage of the transaction data if the storage key is operated. The customer C receives a reserve receipt on which the identification data for identifying the transaction data temporarily stored in the commodity data registration apparatus 102 is printed. Then the customer C inputs the identification data printed on the reserve receipt in the checkout apparatus 103 to read out the stored transaction data from the store server and the like to carry out the settlement processing.

In this way, the commodity data registration apparatus 102 according to the embodiment sends the change amount to the checkout apparatus 103 in a case of over-tend, which can save the commodity data registration apparatus 102 from dispensing the change and printing a receipt. Thus, it is not necessary to arrange a change dispensing machine and a receipt printer in the commodity data registration apparatus 102.

Further, in the present embodiment, two checkout apparatuses 103 that can be selected as the transmission destination of the transaction data are arranged for one commodity data registration apparatus 102. However, the present invention is not limited to this. The checkout apparatus 103 that can be selected as the transmission destination and the number thereof can be set freely.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A commodity data registration apparatus, connected with a checkout apparatus which executes settlement processing of one transaction of a commodity by operations of a customer through a network, comprising:
a specification information determination module configured to determine specification information for specifying an input commodity;
a calculation module configured to calculate a total amount of one transaction according to sales data based on the specified information;
a cash voucher amount input module configured to input a cash voucher amount of one or a plurality of cash vouchers;
a determination module configured to determine whether or not the input cash voucher amount is greater than the calculated total amount;
a change amount calculation module configured to calculate change amount according to the cash voucher amount and the total amount in a case in which it is determined that the cash voucher amount is greater than the total amount; and
a sending module configured to send transaction data containing the calculated change amount, the sales data and the total amount to the checkout apparatus.

2. The commodity data registration apparatus according to claim 1, further comprising:
a selection module configured to select one checkout apparatus in a case in which there is a plurality of checkout apparatuses connected through the network; wherein
the sending module sends the change amount and the transaction data to the selected checkout apparatus.

3. The commodity data registration apparatus according to claim 1, further comprising:
a display control module configured to display the information indicating the checkout apparatus selected as the sending destination and the total amount on a display device at the time of the sending processing carried out by the sending module.

4. The commodity data registration apparatus according to claim 2, further comprising:
a display control module configured to display the information indicating the checkout apparatus selected as the sending destination and the total amount on a display device at the time of the sending processing carried out by the sending module.

5. The commodity data registration apparatus according to claim 1, further comprising:
a cancel module through which it is possible to cancel the input cash voucher amount prior to the sending of the change amount and the transaction data by the sending module.

6. The commodity data registration apparatus according to claim 1, wherein
the input module inputs the type of the cash voucher as well as the cash voucher amount;
further comprising:
a cash voucher information storage module configured to store the input cash voucher amount and the type of the cash voucher in a totalizable manner.

7. A method for executing transmission of a checkout data by a commodity data registration apparatus, including:
determining specification information for specifying an input commodity;
calculating a total amount of one transaction according to sales data based on the specified information;
inputting a cash voucher amount of one or a plurality of cash vouchers;
determining whether or not the input cash voucher amount is greater than the calculated total amount;
calculating change amount according to the cash voucher amount and the total amount in a case in which it is determined that the cash voucher amount is greater than the total amount; and
sending transaction data containing the calculated change amount, the sales data and the total amount to a checkout apparatus.
